(19) United States
(12) Patent Application Publication
(10) Pub. No.: US 2026/0049185 A1
(43) Pub. Date: Feb. 19, 2026

(54) METHOD FOR MAKING ETHER-FUNCTIONAL SILICONES

(71) Applicants: Dow Silicones Corporation, Midland, MI (US); Dow Global Technologies LLC, Midland, MI (US)

(72) Inventors: Shuangbing Han, Midland, MI (US); Zhanjie Li, Midland, MI (US); Jerzy Klosin, Midland, MI (US); Xiaoyun Chen, Midland, MI (US)

(21) Appl. No.: 18/996,199

(22) PCT Filed: Sep. 26, 2023
(86) PCT No.: PCT/US23/75078

§ 371 Date: Jan. 17, 2025

Related U.S. Application Data
(60) Provisional application No. 63/416,061, filed on Oct. 14, 2022.

(51) Int. Cl. C08G 77/382; C08G 77/08

(52) U.S. Cl. CPC C08G 77/382; C08G 77/08

(57) ABSTRACT

A method for making an ether-functional silicone includes hydrosilylation reaction of an acetate-capped alkenyloxy-functional ether and a polyorganohydrogensiloxane in the presence of a catalyst including a bicyclic compound. The method may further comprise preparing the catalyst by combining Karstedt's catalyst with a bicyclic compound to form a complex.

### CROSS REFERENCE TO RELATED APPLICATIONS

This application claims the benefit of U.S. Provisional Patent Application Ser. No. 63/416,061 filed on 14 Oct. 2022 under 35 U.S.C. § 119 (e). U.S. Provisional Patent Application Ser. No. 63/416,061 is hereby incorporated by reference.

### FIELD

A method for making an ether-functional silicone is described herein. More particularly, the method includes hydrosilylation reaction of an acetate-capped alkenyloxy-functional ether and a polyorganohydrogensiloxane in the presence of a catalyst including a bicyclic compound.

### INTRODUCTION

Silicone polyethers (SPEs) have been widely used in multiple markets including beauty care, household care, coatings, leather, antifoams and additives in polyurethane. SPEs may be produced by Pt-catalyzed hydrosilylation between SiH siloxanes and olefin terminated polyethers. The main Pt-catalysts used to produce SPEs via hydrosilylation are platinum (0)-1,3-divinyl-1,1,3,3-tetramethyldisiloxane complex (also known as Karstedt's catalyst as described in U.S. Pat. No. 3,814,730) and chloroplatinic acid (also known as Speier's catalyst as described in U.S. Pat. No. 2,823,218).

However, Karstedt's catalyst and Speier's catalyst often lead to inconsistent reactivity during hydrosilylation reactions between SiH siloxanes and olefin terminated polyethers due to the impurities present in the starting materials. The variable hydrosilylation rates and conversion may result in a negative impact to users of the SPE made by this method.

### SUMMARY

A method for preparing an ether-functional silicone comprises combining (A) an acetate-capped alkenyloxy-functional ether, (B) a polyorganohydrogensiloxane, and (C) a hydrosilylation reaction catalyst. The hydrosilylation reaction catalyst can be prepared by a method comprising combining starting materials comprising i) a platinum (0)—siloxane complex and ii) a bicyclic compound.

### DETAILED DESCRIPTION

In the method for preparing the ether-functional silicone, the hydrosilylation reaction catalyst may be prepared before combining the acetate-capped alkenyloxy-functional ether and/or the polyorganohydrogensiloxane with the hydrosilylation reaction catalyst, or the hydrosilylation reaction catalyst may be prepared in situ. Preparing the hydrosilylation reaction catalyst may be performed by a method comprising: combining starting materials comprising:
i) a platinum (0)—siloxane complex, wherein said complex consists essentially of chemically combined platinum and unsaturated organosiloxane of the formula RₘR′ₙR″ₒSiO₍₄₋ₘ₋ₙ₋ₒ₂, where each R is an independently selected monovalent hydrocarbon radical that is free of aliphatic unsaturation, each R′ is an independently selected monovalent aliphatically unsaturated hydrocarbon radical, each R″ is selected from R′ radicals chemically combined with platinum, subscript m is 0 to 2, subscript n is 0 to 2, subscript o is 0.0002 to 3, and a quantity (m+n+o) is 1 to 3; and
ii) a bicyclic compound selected from the group consisting of

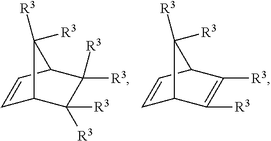

and a combination thereof, where each R³ is independently selected from the group consisting of H, OH, an acetate group, and an ester group.

### i) Platinum (0)—Siloxane Complex

Starting material i), the platinum (0)—siloxane complex, is known in the art and described, for example in U.S. Pat. No. 3,814,730, which is hereby incorporated by reference. The complex may consist essentially of chemically combined platinum and unsaturated organosiloxane of the formula RₘR′ₙR″ₒSiO_{(4-m-n-o)/2}, where each R is an independently selected monovalent hydrocarbon group that is free of aliphatic unsaturation, each R′ is an independently selected monovalent aliphatically unsaturated hydrocarbon group, each R″ is selected from R′ groups chemically combined with platinum, subscript m is 0 to 2, subscript n is 0 to 2, subscript o is 0.0002 to 3, and a quantity (m+n+o) is 1 to 3.

The platinum (0)—siloxane complex may be prepared by combining a platinum halide and an unsaturated organosilicon material, which may be an organosiloxane of formula R_{c}R′ₐSiO_{(4-c-a)/2}, where R and R′ are as described above, subscript c has a value equal to 0 to 2, inclusive, and subscript d has a value equal to 0.0002 to 3, inclusive, and the sum of c and d is equal to 1 to 3, inclusive. The platinum halide may be hexachloroplatinic acid or a metal salt such as NaHPtCl₆·nH₂O, KHPtCl₆ nH₂O, Na₂PtCl₆·nH₂O, or K₂PtCl₆·nH₂O. The complex may be made by effecting contact between the unsaturated organosilicon material and the platinum halide for the production of a mixture having a concentration of inorganic halogen, treating the resulting mixture to effect removal of available inorganic halogen, and recovering the complex.

Alternatively, the unsaturated organosilicon material may be an unsaturated organosiloxane of formula

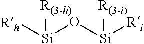

where R is alkyl, R′ is alkenyl, subscript h is an integer of 1 to 3, subscript i is an integer of 1 to 3, and a quantity (h+i)≥2. Suitable alkyl groups for R include methyl, ethyl, propyl and butyl; alternatively methyl and ethyl; and alternatively methyl. Suitable alkenyl groups for R′ include vinyl, allyl, and hexenyl; alternatively vinyl and allyl; and alternatively vinyl. Alternatively, the unsaturated organosiloxane may be selected from the group consisting of 1,3-divinyl-1,1,3,3-tetramethyldisiloxane; 1,1,3-trivinyltrimethyldisiloxane; 1,1,3,3-tetravinyl-1,3-dimethyldisiloxane; and hexavinyldisiloxane.

Alternatively, the complex may be platinum (0)—1,3-divinyl-1,1,3,3-tetramethyldisiloxane complex, e.g., comprising formula

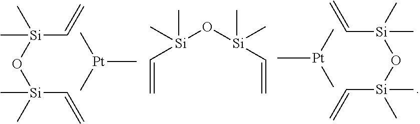

### ii) Bicyclic Compound

Starting material ii) is a bicyclic compound. The bicyclic compound is selected from the group consisting of formula ii-1)

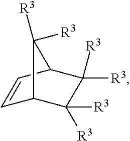

formula ii-2)

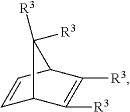

and a combination of both formula ii-1) and formula ii-2), where each R³ is independently selected from the group consisting of H, OH, an acetate group, and an ester group. The acetate group may have formula

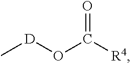

where D is a covalent bond or a divalent hydrocarbon group and R⁴ is an alkyl group of 1 to 6 carbon atoms. The ester group may have formula

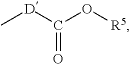

where D′ is a covalent bond or a divalent hydrocarbon group (which may be the same as or different from D, described above), and R⁵ is an alkyl group of 1 to 6 carbon atoms. The divalent hydrocarbon group for D and D′ may have empirical formula —CₓH₂ₓ—, where subscript x is 2 to 10. For example, the divalent hydrocarbon group may be —CH₂—CH₂—, —CH(CH₃)—, —CH₂—CH₂—CH₂—, —CH₂—CH(CH₃)—, —CH₂—CH₂—CH₂—CH₂—, —CH₂—CH₂—CH(CH₃)—, or —CH₂—CH(CH₃)—CH₂—. Alternatively, D may be a covalent bond. Alternatively, D′ may be a covalent bond. Suitable alkyl groups for R⁴ and R⁵ may be independently selected from methyl, ethyl, propyl (including isopropyl and n-propyl), and butyl (including n-butyl, t-butyl, isobutyl, and sec-butyl). Alternatively R⁴ may be methyl or ethyl; alternatively methyl. Alternatively, R⁵ may be butyl, and alternatively t-butyl. Alternatively, the acetate group may be

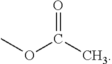

Alternatively, the ester group may be

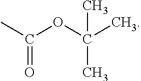

Alternatively, the bicyclic compound may have formula ii-3)

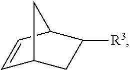

where R³ is as described above. When R³ in this formula is H, the bicyclic compound is (1R,4R)-bicyclol[2.2.1]hept-2-ene (also called norbornene).

Alternatively, the bicyclic compound may have formula ii-4)

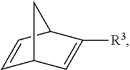

where R³ is as described above. The bicyclic compound may be one or more of the compounds shown below in Table ii).

TABLE ii
Bicyclic Compounds

| Name | Structure | Source |
|---|---|---|
| (1R,4S)-bicyclo [2.2.1]hept-2-ene or norbornene | 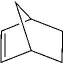 | Sigma Aldrich |
| (1R,2S,4R)-bicyclo [2.2.1]hept-5- en-2-ol or 5- norborene-2-ol | 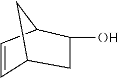 | Sigma Aldrich |
| (1R,4R)-bicyclo [2.2.1]hept-5-en- 2-yl acetate or 5- norbornen-2-yl acetate | 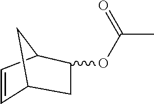 | Sigma Aldrich |
| tert-butyl (1R,2S,4R)- bicyclo[2.2.1] hept-5-ene-2- carboxylate or 5-norbornene-2- carboxylic t-butyl ester | 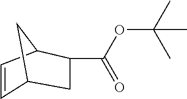 | -TCI America |
| (1s,4s)-bicyclo [2.2.1]hepta-2,5- diene or 2,5-norbornadiene | 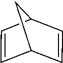 | Sigma Aldrich |
| (1R,4S)-bicyclo [2.2.1]hepta-2,5- dien-2-ol | 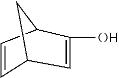 | BOC Sciences |

The i) platinum (0)—siloxane complex and ii) the bicyclic compound described above may be combined by any convenient means, such as mixing at RT or with heating for a time sufficient for ¹⁹⁵Pt NMR spectra to show disappearance of peak belonging to the platinum (0)—siloxane complex (e.g., Karstedt's catalyst) and the appearance of a new peak corresponding to (C) the hydrosilylation reaction catalyst comprising the Pt complex (with the bicyclic compound). Time may be 5 min to 60 min, alternatively 10 min to 60 min, alternatively 30 min. Mixing may be performed under ambient conditions, e.g., ambient pressure in the presence of air. The amounts of i) the platinum (0) siloxane complex and ii) the bicyclic compound are not critical, provided that there is a sufficient amount of both to form the Pt complex. For example, the amount of ii) the bicyclic compound and i) the platinum (0)—siloxane complex may be used in a 1:1 molar ratio of ii) the bicyclic compound to platinum in i) the platinum (0)—siloxane complex {ii):i) ratio}. Alternatively, a molar excess of bicyclic compound can be used. For example, the amount of ii) and i) may be sufficient to provide a molar ii):i) ratio of at least 1:1, alternatively>1:1, alternatively at least 5:1, while at the same time the molar ii):i) ratio may be up to 100:1, alternatively up to 50:1, and alternatively 20:1, of bicyclic compound to platinum in the platinum (0)—siloxane complex.

An exemplary reaction showing formation of (C) a hydrosilylation reaction catalyst described herein from Karstedt's catalyst (Pt (0)—1,3-divinyl-1,1,3,3-tetramethyldisiloxane complex) as starting material i) and norbornene as starting material ii) is shown below in Scheme 1.

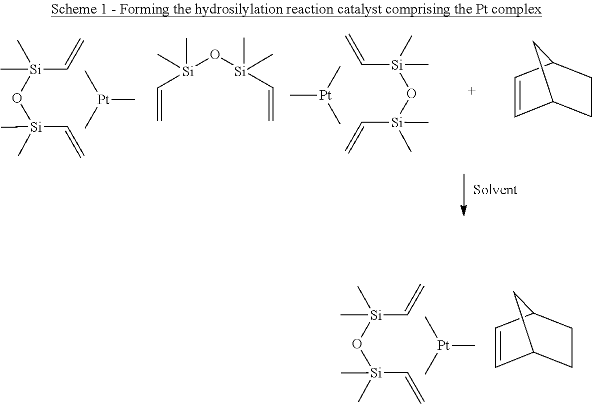

The method for forming the hydrosilylation reaction catalyst may optionally further comprise use of iii) a solvent. The solvent may be used to facilitate combination of i) the platinum (0)—siloxane complex and ii) the bicyclic compound described above. The solvent may be any solvent capable of dissolving) the platinum (0)—siloxane complex and ii) the bicyclic compound, such as an organic solvent, e.g., an aliphatic hydrocarbon, an aromatic hydrocarbon, or a hydrocarbon substituted with a heteroatom, such as an oxygen atom, or a combination thereof. Suitable aromatic hydrocarbons include, for example, benzene, toluene, xylene, and a combination thereof. Suitable heteroatom containing hydrocarbon solvents include THE. The amount of solvent is not critical and any amount sufficient to facilitate contact of i) the platinum (0)—siloxane complex and ii) the bicyclic compound may be used. The solvent may optionally be removed before use of the catalyst (e.g., before combining (C) the hydrosilylation reaction catalyst and (A) the acetate-capped alkenyloxy-functional ether and/or (B) a polyorganohydrogensiloxane used to prepare the ether-functional silicone). Alternatively, the solvent may serve as a vehicle in the method for preparing the ether-functional silicone.

### (A) Acetate-Capped Alkenyloxy-Functional Ether

Starting material (A) in the method for preparing the ether-functional silicone is an acetate-capped alkenyloxy-functional ether. The acetate-capped alkenyloxy-functional ether may have formula:

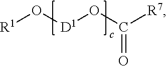

where R¹ is an alkenyl group of 2 to 6 carbon atoms, each D¹ is an independently selected divalent hydrocarbon group of 2 to 10 carbon atoms, R⁷ is an alkyl group of 1 to 6 carbon atoms, and subscript c≥1. Suitable alkenyl groups for R′ are exemplified by vinyl, allyl, and hexenyl; alternatively R¹ may be allyl or hexenyl; and alternatively R′ may be allyl. The divalent hydrocarbon group for D¹ may have empirical formula —C_{y}H_{2y}—, where each subscript y is independently 2 to 10, alternatively 2 to 6, alternatively 2 to 4, and alternatively 2 to 3. For example, each D¹ may be independently selected from —CH₂—CH₂—, —CH(CH₃)—, —CH₂—CH₂—CH₂—, —CH₂—CH(CH₃)—, —CH₂—CH₂—CH₂—CH₂—, CH₂—CH₂—CH(CH₃)—, or CH₂—CH(CH₃)—CH₂—. Alternatively, each D′ may be independently selected from the group consisting of —CH₂—CH₂—, —CH(CH₃)—, —CH₂—CH₂—CH₂—, and —CH₂—CH(CH₃)—. Suitable alkyl groups for R⁷ include methyl, ethyl, propyl (including n-propyl and isopropyl), and butyl (including n-butyl, isobutyl, sec-butyl, and t-butyl) as well as linear or branched alkyl groups of 5 or 6 carbon atoms. Alternatively, R⁷ may be methyl, ethyl, propyl, or butyl. Alternatively, R⁷ may be methyl or ethyl. Alternatively, R⁷ may be methyl. Subscript c represents the number of hydrocarbylene oxide (e.g., alkylene oxide) groups per molecule and has a value of at least 1, alternatively at least 2. Alternatively, subscript c may have a value of 1 to 200, alternatively 2 to 50, alternatively 2 to 30, alternatively 3 to 16, alternatively 4 to 12, alternatively 5 to 10, and alternatively 6 to 8.

Alternatively, the acetate-capped alkenyloxy-functional ether may have formula

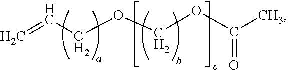

where subscript a is 0 to 4, each subscript b is independently 2 to 10, and subscript c is 2 to 150. Alternatively, subscript a may be 1 and the acetate-capped alkenyloxy-functional ether may be an acetate-capped allyloxy-functional ether. Alternatively, each subscript b may be 2 to 6, alternatively 2 to 4, and alternatively 2 to 3. Alternatively, subscript c may be 2 to 20, alternatively 3 to 16, alternatively 4 to 12, alternatively 5 to 10, and alternatively 6 to 8.

Acetate-capped alkenyloxy-functional ethers are known in the art and are commercially available. For example, an allyloxy-functional ether of formula H₂C═CHCH₂O(CH₂CH₂O)₇COCH₃ is commercially available from The Dow Chemical Company of Midland, Michigan, USA. Other examples of acetate-capped alkenyloxy-functional ethers may be found, for example, in U.S. Pat. No. 3,980,688 at col. 2 line 48 to col. 3, line 29 and col. 8, lines 32-63.

### (B) Polyorganohydrogensiloxane

Starting material (B) in the method for preparing the ether-functional silicone is a polyorganohydrogensiloxane. The polyorganohydrogensiloxane may comprise unit formula (R²₂HSiO_{1/2})_{d}(R²₃SiO_{1/2})ₑ(R²HSiO_{2/2})_{f}(R²₂SiO_{2/2})_{g}(R²SiO_{3/2})ₕ(HSiO_{3/2})ᵢ(SiO_{4/2})ⱼ(ZO_{1/2})ₖ, where each R² is an independently selected monovalent hydrocarbon group, subscript d, e, f, g, h, i, j, and k each represent average numbers of each unit per molecule and have values such that d≥0, e≥0, f≥0, g≥0, h≥0, i≥0, j≥0, and k≥0, with the proviso that a quantity (d+f+i)≥1, and a quantity (d+e+f+g+h+i+j+k)≥2. The subscripts may have values such that 2≥(d+e+f+g+h+i+j)≥10,000. Suitable monovalent hydrocarbon groups for R² may be free of aliphatic unsaturation and include alkyl groups and aryl groups. The alkyl groups may have 1 to 6 carbon atoms. The alkyl groups are exemplified by, but not limited to, methyl, ethyl, propyl (including isopropyl and n-propyl), and butyl (including n-butyl, t-butyl, isobutyl, and sec-butyl). Alternatively, the alkyl groups for R² may be methyl or ethyl; alternatively methyl. The aryl groups for R² may be, for example, phenyl, tolyl, xylyl or naphthyl; alternatively phenyl. Alternatively, each R² may be an alkyl group. Alternatively, each R² may be methyl.

Alternatively, the polyorganohydrogensiloxane may be substantially linear or linear. The substantially linear or linear polyorganohydrogensiloxane may comprise unit formula (R²₂HSiO_{1/2})_{d}(R²₃SiO_{1/2})ₑ(R²HSiO_{2/2})_{f}(R²₂SiO₂/2)_{g}, where R² is as described above, 0≤d≤2; 0≤e≤2; a quantity (d+e)=2; 0≤f≤10; and 0≤g≤50. Alternatively, d may 0 and e may be 2. Alternatively, f may be 2 to 10, alternatively 5 to 10, alternatively 6 to 9, and alternatively 7 to 8. Alternatively, g may be 0 to 40, alternatively 5 to 35, alternatively 10 to 30, alternatively 15 to 25.

Suitable polyorganohydrogensiloxanes for use herein are exemplified by:
(i) α,ω-dimethylhydrogensiloxy-terminated poly(dimethylsiloxane/methylhydrogensiloxane),
(ii) α,ω-dimethylhydrogensiloxy-terminated polymethylhydrogensiloxane,
(iii) α,ω-trimethylsiloxy-terminated poly(dimethylsiloxane/methylhydrogensiloxane),
(iv) α,ω-trimethylsiloxy-terminated polymethylhydrogensiloxane, and
(v) α-dimethylhydrogensiloxy-ω-trimethylsiloxy-terminated
poly(dimethylsiloxane/methylhydrogensiloxane),
(vi) α-dimethylhydrogensiloxy-ω-trimethylsiloxy-terminated polymethylhydrogensiloxane,
(vii) a combination of two or more thereof.

Linear polyorganohydrogensiloxanes are also commercially available, such as those available from Gelest, Inc. of Morrisville, Pennsylvania, USA, for example, HMS-H271, HMS-071, HMS-993; HMS-301 and HMS-301 R, HMS-031, HMS-991, HMS-992, HMS-993, HMS-082, HMS-151, HMS-013, HMS-053, HAM-301, HPM-502, and HMS-HM271. In addition, DOWSIL™ 6-3570 is commercially available from The Dow Chemical Company of Midland, Michigan, USA.

In the method for preparing the ether-functional silicone, (A) the acetate-capped alkenyloxy-functional ether may be used in an amount of 5 weight % to 80 weight %, based on combined weights of starting materials (A), (B), and (C). Starting material (B), the polyorganohydrogensiloxane may be used in an amount of 10 weight % to 90 weight %, based on combined weights of starting materials (A), (B), and (C). Starting material (C), the hydrosilylation reaction catalyst, may be used in an amount of 1 ppm to 0.1 weight %, based on combined weights of starting materials (A), (B), and (C). The exact amount of each starting material depends on various factors, including the structure of the polyorganohydrogensiloxane and its SiH content, and the desired hydrosilylation reaction conditions, such as temperature.

The ether-functional silicone forms via hydrosilylation reaction when starting materials comprising (A) the acetate-capped alkenyloxy-functional ether, (B) the polyorganohydrogensiloxane, and (C) the hydrosilylation reaction catalyst are combined under conditions to effect hydrosilylation reaction of the alkenyl groups of starting material (A) and the silicon bonded hydrogen atoms of starting material (B). For example, one of (A) the acetate-capped alkenyloxy-functional ether and (B) the polyorganohydrogensiloxane and (C) the catalyst prepared as described above, optionally with (D) a vehicle, may be placed in a reactor. The reactor may be equipped with temperature controlling means such as a jacket and with mixing means, such as an agitator and/or baffles. The temperature for hydrosilylation reaction depends on various factors including the amount of (C) the catalyst. The temperature in the reactor may be≥40° C., alternatively 80° C. to 120° C. The hydrosilylation reaction may be performed under inert conditions, e.g., by purging the headspace of the reactor with an inert gas, such as nitrogen or argon. The order of addition is not critical, however, (A) the alkenyloxy-functional ether and (B) the polyorganohydrogensiloxane may be combined in the reactor, and thereafter (C) the catalyst may be added. Alternatively, starting material (A) the alkenyloxy-functional ether and optionally (D) a vehicle may be combined in a reactor. Some or all of (C) the catalyst may be combined with starting material (A). The polyorganohydrogensiloxane may be added over time, either intermittently or continuously, to control any exotherm of the hydrosilylation reaction. The catalyst may also be added over time, to help with controlling the temperature and maintaining the reaction rate.

The vehicle, starting material (D), used for this hydrosilylation reaction is not critical and may be the same as the solvent described above. Alternatively, a different vehicle may be used in addition to, or instead of, the solvent described above for use in preparing the catalyst. For example, (D) the vehicle may be an aliphatic hydrocarbon such as hexane or heptanes; a polar organic solvent, such as isopropyl alcohol, acetone; a heterocyclic compound such as tetrahydrofuran, an aromatic hydrocarbon such as benzene, toluene, or xylene; or a halogenated hydrocarbon in which one or more hydrogen atoms of the aliphatic or aromatic hydrocarbons described above is replaced with a halogen atom such as fluorine or chlorine. The amount of the vehicle is not critical and may vary depending on the purpose. For example, (D) the vehicle may be used to dissolve or disperse one of the starting materials, such as (C) the hydrosilylation reaction catalyst. Alternatively, the hydrosilylation reaction may be performed with all starting materials dissolved in (D) the vehicle, and the amount may be, for example, 0 to 90 weight % vehicle based on combined weights of starting materials (A), (B), (C), and (D).

The method described herein may optionally further comprise one or more additional steps, such as recovery of the ether-functional silicone prepared by the hydrosilylation reaction described above. Recovery may be performed by any convenient means such as stripping and/or distillation with heating and optionally reduced pressure, to remove or minimize the amount (D) vehicle or solvent that may be present and/or to remove or minimize the amount of any unreacted (A) acetate-capped alkenyloxy-functional ether and/or (B) polyorganohydrogensiloxane.

### Method of Use

The ether-functional silicone prepared as described above may be used in markets such as beauty care, household care, coatings, leather, antifoams and additives in polyurethane. For example, the ether-functional silicone prepared as described above may be used in addition to, or instead of, the ether-functional silicones for polyurethane applications such as those disclosed in U.S. Pat. No. 3,980,688 or European Patent Publication EP0275563A1.

### Examples

The following examples are intended to illustrate the invention to one skilled in the art and are not to be interpreted to limit the scope of the invention set forth in the claims. Starting materials used in the examples are described in Table 1.

TABLE 1
Starting Materials

| Starting Material | Description | Source |
|---|---|---|
| Allyloxy-functional | chemical structure: | Commercially |
| ether 1 | CH₂═CHCH₂O(CH₂CH₂O)₇COCH₃ | available from Dow |
| | (AllylEO₇-Acetate) | Chemical |
| Allyloxy-functional | chemical structure: | Commercially |
| ether 2 | CH₂═CHCH₂O(CH₂CH₂O)_{11.8}H | available from Dow |
| | (AllylEO_{11.8}H) | Chemical |
| Organohydrogensiloxane | An organohydrogensiloxane having the | Commercially |
| 1 | following average chemical structure: | available from Dow |
| | (CH₃)₃SiO[(CH₃)₂SiO]₂₂[(CH₃)HSiO]₂Si(CH₃)₃ | Chemical |
| | (MD₂₂D₂^{H}M) | |
| Organohydrogensiloxane | An organohydrogensiloxane having the | Commercially |
| 2 | following average chemical structure: | available from Dow |
| | (CH₃)₃SiO[(CH₃)₂SiO]_{8.7}[(CH₃)HSiO]_{3.7}Si(CH₃)₃ | Chemical |
| | (MD_{8.7}D^{H}_{3.7M}) | |
| Platinum Catalyst | Karstedt's Catalyst (1,1-diethenyl-1,1,3,3- | Synthesize |
| (Pt-Comp-1) | tetramethyldisiloxane platinum complex) | according to |
| | | teachings in |
| | | US1992/5175325 |
| Ligand-1 | 2-Norbornene (Bicyclo[2.2.1]hept-2-ene), | Commercially |
| | CAS#: 498-66-8 | available from |
| | | Sigma Aldrich |
| Acetic anhydride | CAS #: 108-24-7 | Commercially |
| | | available from |
| | | Sigma Aldrich |
| THF | tetrahydrofuran | Commercially |
| | | available from |
| | | Sigma Aldrich |
| Toluene | toluene | |

### Preparation of Catalyst Pt—I-1

To a 20 ml vial were added Ligand-1 (117 mg, 1.24 mmol) and 3 mL toluene. Platinum catalyst, namely Karstedt's Catalyst, (210 mg, 0.247 mmol Pt-metal) was slowly added into the vial, and the reaction mixture was stirred at room temperature for 30 minutes. ¹⁹⁵Pt NMR spectra showed the full disappearance of peak belonging to Karstedt's catalyst (−6167 ppm) and the appearance of a new peak at −6296 ppm (Table 2). This solution containing the in-situ generated catalyst complex was diluted with THE into 0.5 wt % platinum metal concentration, then used for the hydrosilylation reaction without further purification.

### Preparation of Catalyst Pt—I-2

An additional Pt catalyst was prepared in similar procedure to Pt—I-1 except that 234 mg of Ligand-1 was used. Its ¹⁹⁵Pt NMR spectra is identical to that of Pt—I-1 with a single peak at −6296 ppm.

TABLE 2
¹⁹⁵Pt NMR chemical shift of catalyst

| | Chemical shift of Pt (ppm) in the catalyst |
|---|---|
| Pt-Comp-1 | −6167 |
| Pt-I-1 | −6296 |
| Pt-I-2 | −6296 |

### Reference Example 1—Hydrosilylation Reaction Between Organohydrogensiloxane and Allyloxy-Functional Ether

In a typical procedure, a 100-mL 2-neck round-bottom glass flask with magnetic stirring was used as the reaction vessel. Heating was provided by a heated metal plate with concave crater matching the bottom of the flask. The reactions were carried out within a glovebox with negligible oxygen or water level. To the flask were added 22.926 g Organohydrogensiloxane 1 (MD₂₂D₂^{H}M, 12 mmol) and 9.8 g Allyloxy-functional ether 1 (AllylEOr-Acetate, 24 mmol). The mixture in the vial was heated to 80° C. while stirring with a magnetic stirring bar in a pie heating block in a glovebox (N₂). Then the desired amount of the Pt catalyst (as described above) diluted (in THF or toluene) was added into the reaction mixture and the process of the reaction was monitored by in-situ Raman spectroscopy.

Monitoring with Raman Spectroscopy

A B&W Tek i-Raman Pro system with 785 nm laser excitation was used. Spectra were collected in the back-scattering geometry with a Kaiser half-inch diameter short-focus immersion optic. Typical acquisition conditions included: 5 s exposure per scan and 6 scan per spectrum, full laser power (˜300 mW). Spectra were continuously collected at about 32 s intervals.

As shown in Table 3, Pt—I-1 and Pt—I-2 demonstrated higher activities compared with Karstedt's catalyst (Pt-Comp-1) at the same Pt loading and reaction conditions.

TABLE 3
Reactivity comparison between Pt norbornene complex and Karstedt's catalyst

| | Pt | | t_{1/2} (Time to reach | t_{c} (Time to reach >99% |
|---|---|---|---|---|
| | loading | Platinum | 50% of consumption | of consumption of allyl |
| | (ppm) | catalyst used | of allyl groups, min) | groups, min) |
| CE-1 | 2 | Pt-Comp-1 | 2.5 | 11.0 |
| IE-1 | 2 | Pt-Invent-1 | 2.1 | 9.0 |
| | | (Pt/norbornene = 1:5) | | |
| IE-2 | 2 | Pt-Invent-2 | 2.0 | 8.0 |
| | | (Pt/norbornene = 1:10) | | |
| CE-2 | 1 | Pt-Comp-1 | 4.8 | 21.0 |
| IE-3 | 1 | Pt-Invent-1 | 4.0 | 16.3 |
| | | (Pt/norbornene = 1:5) | | |
| IE-4 | 1 | Pt-Invent-2 | 3.6 | 16.2 |
| | | (Pt/norbornene = 1:10) | | |

### Reference Example 2—Hydrosilylation Reactions with Addition of Acetic Anhydride

In a glovebox filled with N₂, Organohydrogensiloxane 1 (22.9 g), Allyloxy-functional ether 1 (9.8 g), and a magnetic stir bar were added to a 100 ml round flask equipped with an in-situ Raman spectroscopy monitoring probe. Then various amounts of acetic anhydride were added to the flask. The mixture in the flask was heated to 80° C. with a pie heating block with stirring. Then diluted platinum catalyst (0.5 wt % Pt in THF) was added into the reaction mixture and the process of the reaction was monitored by in-situ Raman spectroscopy.

Acetic anhydride can poison Karstedt's catalyst (Pt-Comp-1), and the impact of acetic anhydride on the activity of Karstedt's catalyst increased with the increase of loading of acetic anhydride: Pt (mol ratio) as shown in Table 4. When the mole ratio of acetic anhydride to Pt was 3 to 1, acetic anhydride had a small impact on the activity of Karstedt's catalyst as shown in Table 4 (acetic anhydride: Pt=3, t_{1/2}=2.2 min, tc=11.5 as compared to no acetic anhydride, t_{1/2}=2.5 min, t_{c}=11 min). When the mole ratio of acetic anhydride to Pt increased to 5 to 1, the reaction with Karstedt's catalyst took 20 min to complete, which was significantly longer (almost doubled) the reaction time without acetic anhydride.

The inventors surprisingly found that acetic anhydride had a much smaller impact on the activity of the norbornene-Pt complex (Pt—I-1 or Pt—I-2) described above. The norbornene-Pt complex still demonstrated good activity (t_{1/2}=2.2 min and t_{c}=11.15 min) at the mole ratio of acetic anhydride to Pt of 5.

TABLE 4
The comparison of the activities of Karstedt's catalyst
vs Pt-norbornene catalyst in the presence of acetic anhydride

| | Platinum | Platinum | Molar ratio of | t_{1/2} (Time to reach | t_{c} (Time to reach >99.9% |
|---|---|---|---|---|---|
| | loading | catalyst | Acetic anhydride | 50% of consumption | of consumption of allyl |
| | (ppm) | used | to Platinum | of allyl groups, min) | groups, min) |
| CE-1 | 2 | Pt-Comp-1 | 0 | 2.5 | 11.0 |
| CE-3 | 2 | Pt-Comp-1 | 3:1 | 2.2 | 11.5 |
| CE-4 | 2 | Pt-Comp-1 | 5:1 | 2.8 | 20.0 |
| IE-5 | 2 | Pt-I-2 | 3:1 | 1.8 | 7.0 |
| IE-6 | 2 | Pt-I-2 | 5:1 | 2.2 | 11.1 |

These examples showed that under the conditions tested, Pt-1-2 had better reactivity (lower times to consume allyl groups) than Karstedt's Catalyst at the same molar ratio of acetic anhydride: Pt ratio.

### Reference Example 3—Hydrosilylation Reactions with Aged Allyloxy-Functional Ether

A batch of aged Allyloxy-functional ether 1 showed low activity in the hydrosilylation reaction using Karstedt's catalyst, which was thought to be due to impurities generated during the aging process. Norbornene-Pt complex demonstrated higher activity than Karstedt's catalyst in the hydrosilylation reaction with this aged Allyloxy-functional ether 1 (Table 5). The hydrosilylation reaction with 2 ppm Karstedt's catalyst never completed and only reached 50% conversion and the reaction with 2 ppm Pt-norbornene complex completed in about 12 minutes.

TABLE 5
Activity comparison between Karstedt's catalyst and Pt-norbornene
catalyst for aged allyl-functional ether Allyl[EO]₇Acetate.

| | | | t_{1/2} (Time to | t_{c} (Time to |
|---|---|---|---|---|
| | Platinum | Platinum | reach 50% of | reach >99.9% of |
| | loading | catalyst | consumption of | consumption of |
| | (ppm) | used | allyl groups, min) | allyl groups, min) |
| CE-5 | 2 | Pt-Comp-1 | 25 | Reaction stopped |
| | | | | after 50% |
| | | | | conversion |
| CE-6 | 3 | Pt-Comp-1 | 2.5 | 53.0 |
| IE-7 | 2 | Pt-I-1 | 2.3 | 12.0 |
| IE-8 | 3 | Pt-I-1 | 1.3 | 8.0 |

The consumption of allyl groups was plotted against reaction time, and t_{1/2} (Time to reach 50% of consumption of allyl groups) and t_{c} (Time to reach>99.9% of consumption of allyl groups) were recorded in Tables 3, 4, and 5. Data from comparative experiments (CE-1 to CE-6) using Karstedt's catalyst were used as control. Data from working experiments (IE-1 to IE-7) using Pt-1-1 and Pt-1-2 prepared as described above consistently showed shorter reaction time and faster reaction rate than Karstedt's catalyst tested under the same conditions.

### Reference Example 4—Hydrosilylation Reaction with Additional Pt-Invent Catalyst

In a glovebox filled with N₂, Organohydrogensiloxane 2 (10.31 g), Hydroxy end-capped polyether (21.86 g), and a magnetic stir bar were added to a 100 ml round flask equipped with an in-situ Raman spectroscopy monitoring probe. The mixture in the flask was heated to 80° C. with a pie heating block with stirring. Then a diluted platinum catalyst (0.5 wt % Pt in THF) was added into the reaction mixture and the process of the reaction was monitored by in-situ Raman spectroscopy. The catalysts tested are shown below in Table 6.

As shown in Table 6, Pt—I-2 to Pt—I-6 demonstrated similar activities compared with Karstedt's catalyst (Pt-Comp-1) at the same Pt loading and reaction conditions when a hydroxyl-functional polyether is involved. Pt—I-7 demonstrated lower activity compared with Karstedt's catalyst (Pt-Comp-1) and Pt—I-2 to 6.

TABLE 6

| | Pt | | t_{1/2} (Time to reach | t_{c} (Time to reach >99% |
|---|---|---|---|---|
| | loading | Platinum | 50% of consumption | of consumption of |
| | (ppm) | catalyst used | of allyl groups, min) | allyl groups, min) |
| CE-7 | 2 | Pt-Comp-1 | 5.5 | 17 |
| CE-8 | 2 | (Pt/norbornene = 1:10) | 6.2 | 20 |

Comparative Examples CE-7 and CE-8 show that in a hydrosilylation reaction process with an organohydrogenpolysiloxane, the reduction in reactivity observed with Karstedt's catalyst when an acetate-capped allyloxy-functional ether is used did not occur when a hydroxyl-capped allyloxy-functional ether was used to prepare a different ether-functional silicone product. The examples and comparative examples above show that the catalysts used in the process described herein provide an unexpected benefit of reducing reaction time and increasing reaction rate when an acetate-capped alkenyloxy-functional ether is used in a hydrosilylation reaction process with a polyorganohydrogensiloxane.

### INDUSTRIAL APPLICABILITY

The examples above show that a catalyst with a norbornene (or norbornene derivative) ligand provides shorter reaction time and faster reaction rate than Karstedt's catalyst when all other hydrosilylation reaction conditions are the same. ether-functional silicones can be successfully prepared by the method described herein. Without wishing to be bound by theory, it is thought that acetic anhydride (AA) is a primary impurity present in acetate-capped alkenyloxy-functional ethers, such as acetate-capped allyloxy-functional ether, which can poison Karstedt's catalyst and negatively impact hydrosilylation reactivity to form ether-functional silicones. The method described above shows that the catalyst described herein can address this problem and improve hydrosilylation reactivity to form ether-functional silicones.

### Definitions and Usage of Terms

All amounts, ratios, and percentages are by weight unless otherwise indicated by the context of the specification. The articles ‘a’, ‘an’, and ‘the’ each refer to one or more, unless otherwise indicated by the context of the specification. The disclosure of Markush groups includes the entire group and also any individual members and subgroups subsumed therein. For example, disclosure of the Markush group a vinyl, allyl or hexenyl includes the member vinyl individually; the subgroup allyl and hexenyl; and any other individual member and subgroup subsumed therein. Abbreviations used herein are defined below in Table X.

TABLE X
Abbreviations

| Abbreviation | Definition |
|---|---|
| AA | acetic anhydride |
| ° C. | degrees Celsius |
| min | minute |
| RT | room temperature of 23° C. ± 2° C. |

### Embodiments of the Invention

In a first embodiment, a method for preparing an ether-functional silicone comprises: I) combining, under conditions to hydrosilylation reaction, starting materials comprising
(A) an acetate-capped alkenyloxy-functional ether,
(B) a polyorganohydrogensiloxane, and
(C) a hydrosilylation reaction catalyst comprising a Pt (0) complex of formula:

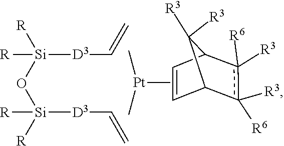

where
[symbol] represents a single bond or a double bond;
each R is an independently selected monovalent hydrocarbon radical that is free of aliphatic unsaturation,
each D³ is independently selected from the group consisting of a covalent bond and a divalent hydrocarbon group of 1 to 4 carbon atoms,
each R⁶ is nothing (not present) when [symbol] is a double bond and each R⁶ is R³ when [symbol] is a single bond;
each R³ is independently selected from the group consisting of H, OH, an acetate group, and an ester group, where
   the ester group has formula

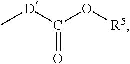

where
D′ is a covalent bond or a divalent hydrocarbon group, and
R⁵ is an alkyl group of 1 to 6 carbon atoms; and
the acetate group has formula

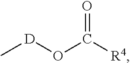

where
D is a covalent bond or a divalent hydrocarbon group, and
R⁴ is an alkyl group of 1 to 6 carbon atoms.

In a second embodiment, in the method of the first embodiment, the Pt (0) complex comprises formula

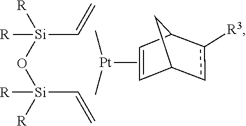

where each R is an alkyl group of 1 to 6 carbon atoms, and R³ is selected from the group consisting of H, OH, the ester group of formula

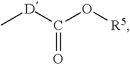

where
D′ is a covalent bond, and
R⁵ is an alkyl group of 1 to 4 carbon atoms; and the acetate group of formula

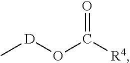

where
D is a covalent bond, and
R⁴ is an alkyl group of 1 to 4 carbon atoms.

In a third embodiment, in the method of the first embodiment or the second embodiment, the Pt (0) complex comprises formula:

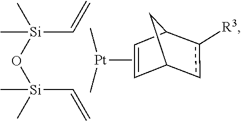

where
R³ is selected from the group consisting of H, OH, an acetate group of formula

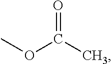

and an ester group of formula

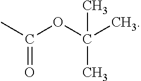

In a fourth embodiment, in the method of any one of the first to third embodiments, the method further comprises an additional step comprising preparation of (C) the hydrosilylation reaction catalyst by a method comprising:
combining starting materials comprising
   i) a platinum (0)—siloxane complex, wherein said complex consists essentially of chemically combined platinum and unsaturated organosiloxane of the formula RₘR′ₙR″ₒSiO_{(4-m-n-o)/2}, where each R is an independently selected monovalent hydrocarbon radical that is free of aliphatic unsaturation, each R′ is an independently selected monovalent aliphatically unsaturated hydrocarbon radical, each R″ is selected from R′ radicals chemically combined with platinum, subscript m is 0 to 2, subscript n is 0 to 2, subscript o is 0.0002 to 3, and a quantity (m+n+o) is 1 to 3;
ii) a bicyclic compound selected from the group consisting of

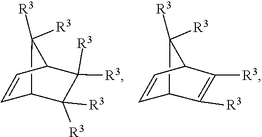

and a combination thereof, where each R³ is independently selected from the group consisting of H, OH, an acetate group, and an ester group; and
optionally iii) a solvent.

In a fifth embodiment, in the method of the fourth embodiment, the Pt (0) complex comprises

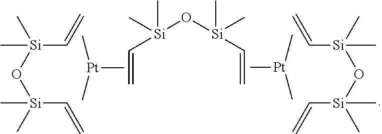

In a sixth embodiment, in the method of the fourth embodiment or the fifth embodiment, the bicyclic compound is selected from the group consisting of (1R,4S)—bicyclo[2.2.1]hept-2-ene; (1R,2S,4R)-bicyclo[2.2.1]hept-5-en-2-ol; (1R,4R)-bicyclo[2.2.1]hept-5-en-2-yl acetate; tert-butyl (1R,2S,4R)-bicyclo[2.2.1]hept-5-ene-2-carboxylate; (1s,4s)-bicyclo[2.2.1]hepta-2,5-diene; and a combination of two or more thereof.

In a seventh embodiment, in the method of any one of the fourth to sixth embodiments, starting material ii) is present in an amount sufficient to provide up to 20 mol of the bicyclic compound, per 1 mol of platinum in the hydrosilylation reaction catalyst.

In an eighth embodiment, in the method of the seventh embodiment, the amount of starting material ii) is sufficient to provide a molar ratio of bicyclic compound: platinum metal of 5:1 to 20:1.

In a ninth embodiment, in the method of any one of the preceding embodiments, (A) the acetate-capped alkenyloxy-functional ether has formula

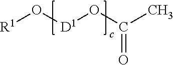

where R¹ is an alkenyl group of 2 to 6 carbon atoms, each D′ is an independently selected divalent hydrocarbon group of 2 to 10 carbon atoms, and subscript c≥2.

In a tenth embodiment, in the method of the ninth embodiment, the acetate-capped alkenyloxy-functional ether has formula

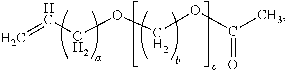

where subscript a is 0 to 4, subscript b is 2 to 10, and subscript c is 2 to 150.

In an eleventh embodiment, in the method of the tenth embodiment, the acetate-capped alkenyloxy-functional ether is an acetate-capped allyloxy-functional ether of formula:

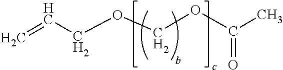

where each subscript b is 2 or 3 and subscript c is 6 to 8.

In a twelfth embodiment, in the method of any one of the preceding embodiments, the polyorganohydrogensiloxane comprises unit formula (R²₂HSiO_{1/2})_{d}(R²₃SiO_{1/2})ₑ(R²HSiO₂/2)_{f}(R²₂SiO₂/2)_{g}, where each R² is an independently selected monovalent hydrocarbon group, subscripts d, e, f, and g represent average amounts, per molecule, of each unit in the formula and have values such that 0≤d≤2; 0 S e≤2; a quantity (d+e)=2; 0≤fS 10; and 0≤g≤50.

In a thirteenth embodiment, in the method of the twelfth embodiment, each R² is a methyl group.

1. A method for preparing an ether-functional silicone, wherein the method comprises:
1) combining starting materials comprising:
i) a platinum (0)—siloxane complex, wherein said complex consists essentially of chemically combined platinum and unsaturated organosiloxane of the formula RₘR′ₙR″ₒSiO_{(4-m-n-o)/2}, where each R is an independently selected monovalent hydrocarbon radical that is free of aliphatic unsaturation, each R′ is an independently selected monovalent aliphatically unsaturated hydrocarbon radical, each R″ is selected from R′ radicals chemically combined with platinum, subscript m is 0 to 2, subscript n is 0 to 2, subscript o is 0.0002 to 3, and a quantity (m+n+o) is 1 to 3;
ii) a bicyclic compound selected from the group consisting of 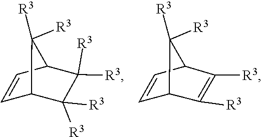
and a combination thereof,
where each R³ is independently selected from the group consisting of H, OH, an acetate group, and an ester group; and
optionally iii) a solvent;
optionally 2) diluting the product of step 1) in a vehicle,
thereby producing (C) a hydrosilylation reaction catalyst comprising a Pt complex;
3) combining starting materials comprising
(A) an acetate-capped alkenyloxy-functional ether,
(B) a polyorganohydrogensiloxane,
(C) the hydrosilylation reaction catalyst.

2. The method of claim 1, where the unsaturated organosiloxane has formula 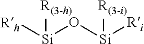
where R is alkyl, R′ is alkenyl, subscript h is an integer of 1 to 3, subscript i is an integer of 1 to 3, and a quantity (h+i)≥2.

3. The method of claim 1, where starting material i) comprises platinum (0)—1,3-divinyl-1,1,3,3-tetramethyldisiloxane complex.

4. The method of claim 1, where starting material ii) the bicyclic compound has a formula selected from the group consisting of 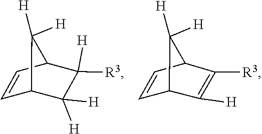
and a combination thereof; where each R³ is independently selected from the group consisting of —OH; an ester group of formula 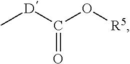
where D′ is a covalent bond or a divalent hydrocarbon group, and R⁵ is an alkyl group of 1 to 6 carbon atoms; and an acetate group of formula 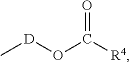
where D is a covalent bond or a divalent hydrocarbon group and R⁴ is an alkyl group of 1 to 6 carbon atoms.

5. The method of claim 4, where starting material ii) the bicyclic compound is selected from the group consisting of:

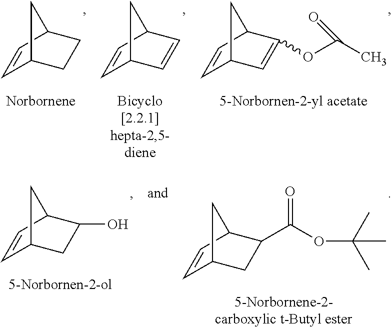

6. The method of claim 5, where starting material ii) the bicyclic compound is Norbornene.

7. The method of claim 1, where the acetate-capped alkenyloxy-functional ether has formula 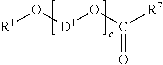
where R¹ is an alkenyl group of 2 to 6 carbon atoms, each D¹ is an independently selected divalent hydrocarbon group of 2 to 10 carbon atoms, R⁷ is an alkyl group of 1 to 6 carbon atoms, and subscript c≥1.

8. The method of claim 7, where the acetate-capped alkenyloxy-functional ether has formula 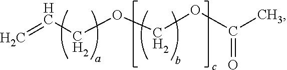
where subscript a is 0 to 4, subscript b is 2 to 10, and subscript c is 2 to 150.

9. The method of claim 1, where the polyorganohydrogensiloxane comprises unit formula (R²₂HSiO_{1/2})_{d}(R²₃SiO_{1/2})ₑ(R²HSiO_{2/2})_{f}(R²₂SiO_{2/2})_{g}(R²SiO_{3/2})ₕ(HSiO_{3/2})ᵢ(SiO_{4/2})ⱼ(ZO_{1/2})ₖ, where each R² is an independently selected monovalent hydrocarbon group, subscript d, e, f, g, h, I, j, and k each represent average numbers of each unit per molecule and have values such that d≥0, e≥0, f≥0, g≥0, h≥0, i≥0, j≥0, and k≥0, with the proviso that a quantity (d+f+i)≥1, and a quantity (d+e+f+g+h+i+j+k)≥2.

10. The method of claim 9, where the polyorganohydrogensiloxane comprises unit formula (R²₂HSiO_{1/2})_{d}(R²₃SiO_{1/2})ₑ(R²HSiO₂/2)_{f}(R²₂SiO_{2/2})_{g}, where R² is as described above, 0≤d≤2; 0≤e≤2; a quantity (d+e)=2; 0≤f≤10; and 0≤g≤50; and a quantity (d+f)≥1.

11. The method of claim 1, where starting material ii) is present in an amount sufficient to provide up to 20 mol of the bicyclic compound, per 1 mol of platinum in the hydrosilylation reaction catalyst.

12. The method of claim 1, where the solvent is present in step 1), and the solvent is selected from the group consisting of an aliphatic hydrocarbon, an aromatic hydrocarbon, and a combination thereof.

13. The method of claim 1, where step 1) is performed by mixing at a temperature of at 20° C. to 30° C., step 2) is performed by mixing and heating at a temperature of 40° C. to 120° C., or both.

14. The method of claim 1, where the method further comprises, prior to step 1), forming starting material i), the platinum (0)—siloxane complex, by a method comprising mixing a platinum halide and the unsaturated siloxane to form a mixture, and thereafter treating the mixture to effect the removal of available inorganic halogen.

15. An ether-functional silicone copolymer prepared by a method comprising:
1) combining starting materials comprising:
i) a platinum (0)—siloxane complex, wherein said complex consists essentially of chemically combined platinum and unsaturated organosiloxane of the formula RₘR′ₙR″ₒSiO_{(4-m-n-o)/2}, where each R is an independently selected monovalent hydrocarbon radical that is free of aliphatic unsaturation, each R′ is an independently selected monovalent aliphatically unsaturated hydrocarbon radical, each R″ is selected from R′ radicals chemically combined with platinum, subscript m is 0 to 2, subscript n is 0 to 2, subscript o is 0.0002 to 3, and a quantity (m+n+o) is 1 to 3;
ii) a bicyclic compound selected from the group consisting of 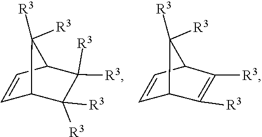
and a combination thereof, where each R³ is independently selected from the group consisting of H, OH, an acetate group, and an ester group; and
optionally iii) a solvent;
optionally 2) diluting the product of step 1) in a vehicle,
thereby producing (C) a hydrosilylation reaction catalyst comprising a Pt complex;
3) combining starting materials comprising
(A) an acetate-capped alkenyloxy-functional ether,
(B) a polyorganohydrogensiloxane,
(C) the hydrosilylation reaction catalyst;
thereby preparing a product comprising the ether-functional silicone copolymer and
the hydrosilylation reaction catalyst comprising the Pt complex.

16. The method of claim 11, wherein the amount of starting material ii) is sufficient to provide a molar ratio of bicyclic compound: platinum metal of 5:1 to 20:1.
